(19) United States
(12) Patent Application Publication
(10) Pub. No.: US 2022/0121059 A1
(43) Pub. Date: Apr. 21, 2022

(54) DISPLAY PANEL AND DISPLAY DEVICE

(71) Applicant: Shenzhen China Star Optoelectronics Semiconductor Display Technology Co., LTD., Shenzhen, Guangdong (CN)

(72) Inventors: Lisha LUO, Shenzhen, Guangdong (CN); Bangyin PENG, Shenzhen, Guangdong (CN); Ilgon KIM, Shenzhen, Guangdong (CN)

(21) Appl. No.: 16/767,666

(22) PCT Filed: Apr. 29, 2020
(86) PCT No.: PCT/CN2020/087672

§ 371 Date: May 28, 2020

(30) Foreign Application Priority Data
Apr. 15, 2020 (CN) 202010296913.8

(51) Int. Cl. G02F 1/1335; G02F 1/1339

(52) U.S. Cl. CPC G02F 1/133512; G02F 1/133514; G02F 1/1339

(57) ABSTRACT

The present application provides a display panel and a display device. The display panel includes a display region and an edge region arranged at sides of the display region. The display panel includes a first substrate and a second substrate corresponding to each other. The first substrate or/and the second substrate is provided with a light shielding layer in the edge region.

### FIELD OF DISCLOSURE

The present disclosure generally relates to a field of display technologies and, more particularly, relates to a display panel and a display device.

### DESCRIPTION OF RELATED ART

At present, a large black matrix (BM) is arranged on a display panel for shielding light to avoid light leakage. A lot of metal is provided under the BM and arranged in, for example, a display region of the display panel. The metal reflects light, so the intensity of light irradiated on the BM is low, and the light cannot penetrate the BM.

However, in areas where no metal is provided under the BM, such as an edge region of the display panel, light will penetrate the BM when the light intensity is high, thereby causing light leakage at edges and affecting display quality.

In regard to conventional display panels, in an area where no metal is disposed under a black matrix (BM), such as an edge region of a display panel, light will penetrate the BM when the light intensity is high, which results in light leakage at edges and affecting display quality.

### SUMMARY

In one aspect, the present application provides a display panel with a display region and an edge region disposed at a plurality of sides of the display region, the display panel comprising:

a first substrate and a second substrate disposed corresponding to each other;

wherein a light shielding layer is disposed in the edge region on the first substrate or/and the second substrate.

In some embodiments, the first substrate comprises a first base substrate and a color resist layer disposed on one side of the first base substrate adjacent to the second substrate, and the light shielding layer and the color resist layer are disposed in a same layer.

In some embodiments, material of the light shielding layer is the same as material of the color resist layer.

In some embodiments, the material of the light shielding layer comprises a blue color resist.

In some embodiments, the display panel further comprises a sealant disposed between the first substrate and the second substrate, and the light shielding layer is disposed inside the sealant.

In some embodiments, a black matrix is disposed on the first substrate or/and the second substrate, and an orthographic projection of the black matrix projected on the first substrate covers an orthographic projection of the light shielding layer projected on the first substrate.

In some embodiments, the edge region comprises a first edge region and a second edge region, the display panel further comprises a signal input terminal disposed in the second edge region, and the light shielding layer is disposed in the first edge region.

In some embodiments, the first edge region and the second edge region are disposed at different sides of the display region.

In some embodiments, an orthographic projection of the light shielding layer projected on the first substrate covers an orthographic projection of the first edge region projected on the first substrate.

In another aspect, the present application further provides a display device, wherein the display device comprises a driving module and a display panel, the display panel comprises a display region and an edge region disposed at a plurality of sides of the display region, and the display panel comprises a first substrate and a second substrate disposed corresponding to each other;

wherein a light shielding layer is disposed in the edge region on the first substrate or/and the second substrate, and the driving module is electrically connected to a signal input terminal of the display panel.

In still another aspect, the present application further provides a display panel, wherein the display panel comprises a display region and an edge region disposed at a plurality of sides of the display region, and the display panel comprises a first substrate and a second substrate disposed corresponding to each other;

wherein the first substrate is an array substrate, the second substrate is a color filter substrate, and a light shielding layer is disposed in the edge region on the first substrate or/and the second substrate.

In some embodiments, the first substrate comprises a first base substrate and a color resist layer disposed on one side of the first base substrate adjacent to the second substrate, and the light shielding layer and the color resist layer are disposed in a same layer.

In some embodiments, material of the light shielding layer is the same as material of the color resist layer.

In some embodiments, the material of the light shielding layer comprises a blue color resist.

In some embodiments, the display panel further comprises a sealant disposed between the first substrate and the second substrate, and the light shielding layer is disposed inside the sealant.

In some embodiments, a black matrix is disposed on the first substrate or/and the second substrate, and an orthographic projection of the black matrix projected on the first substrate covers an orthographic projection of the light shielding layer projected on the first substrate.

In some embodiments, the edge region comprises a first edge region and a second edge region, the display panel further comprises a signal input terminal disposed in the second edge region, and the light shielding layer is disposed in the first edge region.

In some embodiments, the first edge region and the second edge region are disposed at different sides of the display region.

In some embodiments, an orthographic projection of the light shielding layer projected on the first substrate covers an orthographic projection of the first edge region projected on the first substrate.

In some embodiments, a light blocking layer is disposed on side portions of the first substrate and the second substrate, and the light blocking layer covers a gap between the first substrate and the second substrate.

Advantages of the present application:

By providing the light shielding layer at the edge region, the light shielding layer and the black matrix provides a combined effect. Therefore, for the edge region where no metal is provided, even when light with greater intensity can penetrate one of the light shielding layer and the black matrix, the light is still blocked by the other one of the light shielding layer and the black matrix, thus avoiding light leakage at edges, which can affect the display quality. Furthermore, the light shielding layer and the color resist layer can be made of the same material through a same manufacturing step, without increasing production costs and an overall thickness of the display panel.

### BRIEF DESCRIPTION OF DRAWINGS

Technical solutions and other beneficial effects of the present application will be apparent through a detailed description provided below in conjunction with the accompanying drawings and specific embodiments.

FIG. 1 is a schematic structural view illustrating a display panel according to one embodiment of the present application.

FIG. 2 is a schematic view illustrating transmittance of light in different wavelength bands through photoresists of different colors.

FIG. 3 is a schematic plan view illustrating a first substrate according to one embodiment of the present application.

FIG. 4 is a partial schematic view illustrating the first substrate according to one embodiment of the present application.

FIG. 5 is a schematic structural view illustrating the first substrate according to one embodiment of the present application.

FIG. 6 is a schematic structural view illustrating a display device according to one embodiment of the present application.

### DETAILED DESCRIPTION OF EMBODIMENTS

A description is provided below to illustrate specific embodiments with reference to the accompanying drawings and in conjunction with specific embodiments of the present application. The directional terms mentioned in the present invention, such as “upper”, “lower”, “front”, “rear′, “left”, “right”, “inner”, “outer”, and “lateral” are only for illustrative purposes based on the accompanying drawings. Therefore, the directional terms are only used for ease of description and understanding of the present invention, not to limit the present invention. In the drawings, structurally similar elements are denoted by the same reference numerals.

The present invention aims to solve a problem in conventional display panel. The problem is that, in an area where no metal is provided under a black matrix (BM), such as an edge region of the display panel, light penetrates the BM when light intensity is high, thereby causing light leakage at edges and affecting display quality.

FIG. 1 shows a display panel 10. The display panel 10 comprises a display region 11 and an edge region 12 disposed at a plurality of sides of the display region 11. The display panel 10 comprises a first substrate 13 and a second substrate 14 disposed corresponding to each other. The first substrate 13 can be an array substrate, and the second substrate 14 can be a color filter substrate.

In detail, the first substrate 13 includes a first base substrate 131, a first alignment film layer 133 disposed on one side of the first base substrate 131 adjacent to the second substrate 14, and a first polarizer 134 disposed on one side of the first base substrate 131 away from on the second substrate 14.

Specifically, the second substrate 14 comprises a second base substrate 141, a second alignment film layer 142 disposed on one side of the second base substrate 141 adjacent to the first substrate 13, and a second polarizer 143 disposed on one side of the second base substrate 141 away from on the first substrate 13.

Specifically, a backlight module 15 includes a back frame 151 and a backlight 152 disposed at one side of the first substrate 13 away from the second substrate 14. The back frame 151 is adhered by an adhesive layer 161 to one side of the first substrate 13 away from the second substrate 14.

Specifically, a light shielding layer 162 is disposed in the edge region 12 on the first substrate 13 or/and the second substrate 14.

A black matrix 163 in the display region 11 and the edge region 12 is arranged on the first substrate 13 or/and the second substrate 14. The black matrix 163 and the light shielding layer 162 are not arranged in the same layer.

It should be noted that, by providing the light shielding layer 162 in the edge region 12, the light shielding layer 162 and the black matrix 163 provides a combined effect. Therefore, in the edge region 12 where no metal is provided, even when light with greater intensity can penetrate one of the light shielding layer 162 and the black matrix 163, the light is still blocked by the other one of the light shielding layer 162 and the black matrix 163, thus avoiding light leakage at edges, which can affect the display quality.

It should be noted that FIG. 1 only illustrates a case where the light shielding layer 162 is disposed between the first base substrate 131 and the first alignment film layer 133. In practice, the light shielding layer 162 can also be disposed on other film layer of the first substrate 13, and the light shielding layer 162 can also be disposed on the second substrate 14.

In detail, an orthographic projection of the black matrix 163 projected on the first substrate 13 covers an orthographic projection of the light shielding layer 162 projected on the first substrate 13, so as to improve light shielding effects.

In one embodiment, the black matrix 163 is disposed between the second base substrate 141 and the second alignment film layer 142.

The display panel 10 further includes a sealant 164 disposed between the first substrate 13 and the second substrate 14, and an accommodating chamber is formed between the sealant 164, the first substrate 13, and the second substrate 14. A liquid crystal layer 165 is disposed in the accommodating chamber 165, and the light shielding layer 162 is disposed inside the sealant 164 to reduce a bezel width of the display panel 10.

To be specific, a light blocking layer 166 is disposed on side portions of the first substrate 13 and the second substrate 14. The light blocking layer 166 covers a gap between the first substrate 13 and the second substrate 14 to prevent light from passing through the sealant 164 and leaking out from the edges, and also prevent moisture from entering the display panel 10 through the gap.

In one embodiment, the first substrate 13 further includes a color resist layer 132 disposed on one side of the first base substrate 131 adjacent to the second substrate 14, and the light shielding layer 162 and the color resist layer 132 are arranged in the same layer to reduce an overall thickness of the display panel 10.

The color resist layer 132 includes a plurality of color resist blocks arranged at intervals. The color resist blocks can be composed of one or more of a red color resist block, a blue color resist block, and a green color resist block. The black matrix 163 is arranged corresponding to the interval between each two adjacent color resist blocks.

It should be noted that the color resist layer 132 can be disposed between the first base substrate 131 and the first alignment film layer 133, and the color resist layer 132 can also be disposed between the second base substrate 141 and the second alignment film layer 142.

Specifically, the light shielding layer 162 is made of the same material as the color resist layer 132, and the light shielding layer 162 and the color resist layer 132 can be formed through a same manufacturing step. For example, after a color resist film layer is formed on the first base substrate 131 by using a color resist material, the color resist film layer is patterned to form the color resist layer 132 and the light shielding layer 162. Accordingly, manufacturing steps of the display panel 10 are reduced, and production costs are lowered.

In detail, material of the light shielding layer 162 comprises a blue color resist. It should be noted that light rays of different colors have different transmittances through the black matrix 163. Generally, long-wavelength light (such as red light) has high transmittances through the black matrix 163, so red light easily penetrates the black matrix 163.

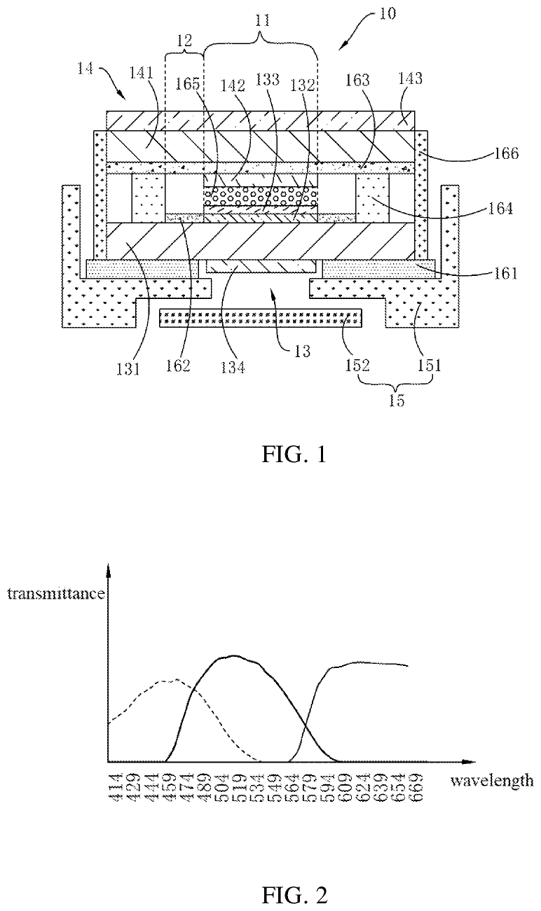

Please refer to FIG. 2, which is a schematic view illustrating transmittance of light with different wavelengths through photoresists of different colors. In FIG. 2, an ordinate indicates transmittance, an abscissa indicates wavelength of the light, and a dotted line indicates transmittance through a blue color resist. A thick solid line indicates transmittance through a green color resist, and a thin solid line indicates transmittance through a red color resist. It can be known from FIG. 2 that long-wavelength light has low transmittances through the blue color resist, so the blue color resist can be used to provide good effects in shielding the long-wavelength light, thus further improving light shielding effects and avoiding light leakage at edges, which affects the display quality.

It should be noted that, the light blocking layer 166 and the light shielding layer 162 can be made of the same material to provide stronger light shielding effects. The light blocking layer 166 and the light shielding layer 162 can also be made of different materials. For example, the material of the light blocking layer 166 is a green color resist or a red color resist. Light in a short wavelength band has low transmittance through the green color resist and the red color resist, and the light blocking layer 166 and the light shielding layer 162 can complement each other.

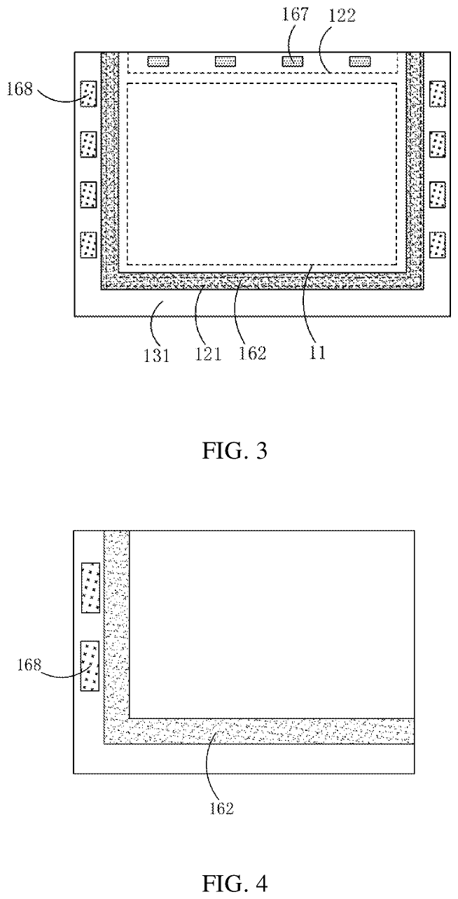

Specifically, as shown in FIGS. 3 and 4, the edge region 12 comprises a first edge region 121 and a second edge region 122, and the display panel 10 further comprises a signal input terminal 167 located at the second edge region 122, the light shielding layer 162 is arranged in the first edge region 121.

It should be noted that, the signal input terminal 167 is made of a metal material, the signal input terminal 167 can be connected to a driving module 20 outside the display panel 10 to receive input signals provided by the driving module 20, and the signal input terminal 167 is a metal block. The light emitted by the backlight 152 is reflected from the signal input terminal 167 to prevent light of greater intensity from directly irradiating the black matrix 163 to cause light leakage at edges. Therefore, the light shielding layer 162 can be provided only in the first edge region 121, and there is no need to have the light shielding layer 162 in the second edge region 122 where the signal input terminal 167 is arranged, thus reducing production costs and also preventing the connection between the signal input terminal 167 and the driving module 20 from being hindered by the light shielding layer 162.

Specifically, the first edge region 121 and the second edge region 122 are located at different sides of the display region 11.

Specifically, an orthographic projection of the light shielding layer 162 projected on the first substrate 13 covers an orthographic projection of the first edge region 121 projected on the first substrate 13 to improve light shielding effects.

In one embodiment, the first substrate 13 is provided with a plurality of gate-on-array (GOA) driving units 168 located at one side of the first edge region 121 away from the display region 11. The GOA driving units 168 are arranged longitudinally at intervals, and the GOA driving unit 168 provides driving signals for the display panel 10.

It should be noted that, the GOA driving unit 168 can be disposed on only one side of the first substrate 13, or the GOA driving unit 168 can be disposed on multiple sides of the first substrate 13.

It should be noted that, the light shielding layer 162 can cover the GOA driving unit 168 or not.

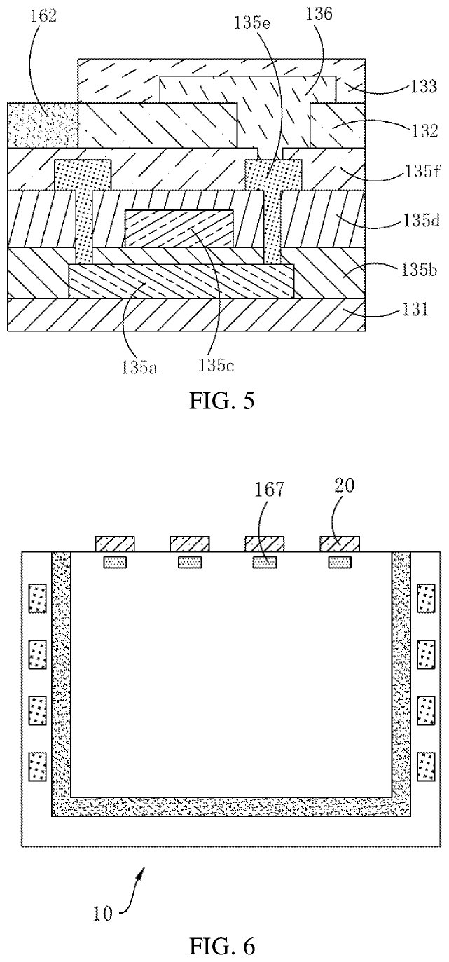

As shown in FIG. 5, the first substrate 13 further comprises an active layer 135a disposed on the first base substrate 131, a gate insulating layer 135b covering the active layer 135a, and a gate electrode 135c disposed on the gate insulating layer 135b, an interlayer dielectric layer 135d covering the gate electrode 135c, a source/drain electrode 135e disposed on the interlayer dielectric layer 135d and electrically connected to the active layer 135a, and a passivation layer 135f covering the source/drain electrode 135e.

The color resist layer 132 and the light shielding layer 162 are disposed on the passivation layer 135f, and the color resist layer 132 is further provided with a pixel electrode 136 electrically connected to the source/drain electrode 135e. The first alignment film layer 133 covers the pixel electrode 136.

Based on the above display panel 10, the present application further provides a display device. The display device comprises a driving module 20 and the display panel 10 described in any of the above embodiments. The driving module 20 is electrically connected to the signal input terminal 167 of the display panel 10 to drive the display panel 10 to operate normally.

It should be noted that, the driving module 20 can be a flip chip film board or other printed circuit board.

Advantages of the present application:

By providing the light shielding layer 162 at the edge region 12, the light shielding layer 162 and the black matrix 163 provides a combined effect. Therefore, in the edge region 12 where no metal is provided, even when light with greater intensity can penetrate one of the light shielding layer 162 and the black matrix 163, the light is still blocked by the other one of the light shielding layer 162 and the black matrix 163, thus avoiding light leakage at edges, which can affect the display quality. Furthermore, the light shielding layer 162 and the color resist layer 132 can be made of the same material through a same manufacturing step, without increasing production costs and an overall thick-ness of the display panel 10.

In the above embodiments, the description of each embodiment has its own emphasis. For those that are not described in detail in one embodiment, related descriptions can be found in other embodiments.

The present invention is described in detail above. Specific examples are provided to explain the working principles and embodiments of the present invention. The descriptions of the above embodiments are only for ease of understanding of the technical solution and main ideas of the present invention. Those of ordinary skill in the art should be able to modify the technical solutions described in the foregoing embodiments, or equivalently replace some of the technical features. Such modifications or replacements are deemed to be within the protection scope of the present invention.

What is claimed is:

1. A display panel with a display region and an edge region disposed at a plurality of sides of the display region, the display panel comprising:
a first substrate and a second substrate disposed corresponding to each other;
wherein a light shielding layer is disposed in the edge region on the first substrate or/and the second substrate.

2. The display panel according to claim 1, wherein the first substrate comprises a first base substrate and a color resist layer disposed on one side of the first base substrate adjacent to the second substrate, and the light shielding layer and the color resist layer are disposed in a same layer.

3. The display panel according to claim 2, wherein material of the light shielding layer is the same as material of the color resist layer.

4. The display panel according to claim 3, wherein the material of the light shielding layer comprises a blue color resist.

5. The display panel according to claim 2, wherein the display panel further comprises a sealant disposed between the first substrate and the second substrate, and the light shielding layer is disposed inside the sealant.

6. The display panel according to claim 2, wherein a black matrix is disposed on the first substrate or/and the second substrate, and an orthographic projection of the black matrix projected on the first substrate covers an orthographic projection of the light shielding layer projected on the first substrate.

7. The display panel according to claim 1, wherein the edge region comprises a first edge region and a second edge region, the display panel further comprises a signal input terminal disposed in the second edge region, and the light shielding layer is disposed in the first edge region.

8. The display panel according to claim 7, wherein the first edge region and the second edge region are disposed at different sides of the display region.

9. The display panel according to claim 7, wherein an orthographic projection of the light shielding layer projected on the first substrate covers an orthographic projection of the first edge region projected on the first substrate.

10. A display device, wherein the display device comprises a driving module and a display panel, the display panel comprises a display region and an edge region disposed at a plurality of sides of the display region, and the display panel comprises a first substrate and a second substrate disposed corresponding to each other;
wherein a light shielding layer is disposed in the edge region on the first substrate or/and the second substrate, and the driving module is electrically connected to a signal input terminal of the display panel.

11. A display panel, wherein the display panel comprises a display region and an edge region disposed at a plurality of sides of the display region, and the display panel comprises a first substrate and a second substrate disposed corresponding to each other;
wherein the first substrate is an array substrate, the second substrate is a color filter substrate, and a light shielding layer is disposed in the edge region on the first substrate or/and the second substrate.

12. The display panel according to claim 11, wherein the first substrate comprises a first base substrate and a color resist layer disposed on one side of the first base substrate adjacent to the second substrate, and the light shielding layer and the color resist layer are disposed in a same layer.

13. The display panel according to claim 12, wherein material of the light shielding layer is the same as material of the color resist layer.

14. The display panel according to claim 13, wherein the material of the light shielding layer comprises a blue color resist.

15. The display panel according to claim 12, wherein the display panel further comprises a sealant disposed between the first substrate and the second substrate, and the light shielding layer is disposed inside the sealant.

16. The display panel according to claim 12, wherein a black matrix is disposed on the first substrate or/and the second substrate, and an orthographic projection of the black matrix projected on the first substrate covers an orthographic projection of the light shielding layer projected on the first substrate.

17. The display panel according to claim 11, wherein the edge region comprises a first edge region and a second edge region, the display panel further comprises a signal input terminal disposed in the second edge region, and the light shielding layer is disposed in the first edge region.

18. The display panel according to claim 17, wherein the first edge region and the second edge region are disposed at different sides of the display region.

19. The display panel according to claim 17, wherein an orthographic projection of the light shielding layer projected on the first substrate covers an orthographic projection of the first edge region projected on the first substrate.

20. The display panel according to claim 11, wherein a light blocking layer is disposed on side portions of the first substrate and the second substrate, and the light blocking layer covers a gap between the first substrate and the second substrate.
